(19) United States
(12) Patent Application Publication
(10) Pub. No.: US 2020/0310267 A1
(43) Pub. Date: Oct. 1, 2020

(54) ELECTROPHOTOGRAPHIC PHOTORECEPTOR, PROCESS CARTRIDGE, AND IMAGE FORMING APPARATUS

(71) Applicant: FUJI XEROX CO., LTD., Tokyo (JP)

(72) Inventor: Takeshi KAWAI, Kanagawa (JP)

(73) Assignee: FUJI XEROX CO., LTD., Tokyo (JP)

(21) Appl. No.: 16/725,108

(22) Filed: Dec. 23, 2019

(30) Foreign Application Priority Data
Apr. 1, 2019 (JP) 2019-070041

(51) Int. Cl. G03G 5/14; G03G 21/18; G03G 15/00

(52) U.S. Cl. CPC G03G 5/144; G03G 15/75; G03G 21/1803

(57) ABSTRACT

An electrophotographic photoreceptor includes: a conductive substrate; an undercoating layer which is provided on the conductive substrate and contains a binder resin and metal oxide particles; and a photosensitive layer provided on the undercoating layer, wherein, with respect to a surface of the undercoating layer, on which the photosensitive layer is provided, a ratio of an abundance of a metallic element to an abundance of a metallic element and a carbon element, which are detected by X-ray photoelectron spectroscopic analysis, is 3.9% or less.

### CROSS-REFERENCE TO RELATED APPLICATIONS

This application is based on and claims priority under 35 USC 119 from Japanese Patent Application No. 2019-070041 filed on Apr. 1, 2019.

### BACKGROUND

### (i) Technical Field

The present invention relates to an electrophotographic photoreceptor, a process cartridge, and an image forming apparatus.

### (ii) Related Art

JP-A-7-013388 discloses “an electrophotographic lithographic printing plate precursor in which a photoconductive layer containing at least a photoconductive substance containing zinc oxide and a resin binder is provided on a paper support and an exposure rate of the zinc oxide on a surface of the photoconductive layer is from 2.1% to 5%”.

### SUMMARY

In a case where an image is formed by applying an electrophotographic photoreceptor including an undercoating layer containing a binder resin and metal oxide particles, color spots (for example, black spots) may be generated, and there is room for further improvement.

Aspects of non-limiting embodiments of the present disclosure relate to an electrophotographic photoreceptor including an undercoating layer containing a binder resin and metal oxide particles, which prevents a color spot, as compared with a case where, with respect to a surface of the undercoating layer, on which the photosensitive layer is provided, a ratio obtained from an abundance of a metallic element to an abundance of a metallic element and a carbon element, which are detected by X-ray photoelectron spectroscopic analysis, is more than 3.9%.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electrophotographic photoreceptor including:

a conductive substrate;

an undercoating layer which is provided on the conductive substrate and contains a binder resin and metal oxide particles; and

a photosensitive layer provided on the undercoating layer,

wherein, with respect to a surface of the undercoating layer, on which the photosensitive layer is provided, a ratio of an abundance of a metallic element to an abundance of a metallic element and a carbon element, which are detected by X-ray photoelectron spectroscopic analysis, is 3.9% or less.

### BRIEF DESCRIPTION OF THE DRAWINGS

Exemplary embodiments of the present invention will be described in detail based on the following figures, wherein:

FIG. 1 is a schematic sectional diagram illustrating an example of a layer configuration of an electrophotographic photoreceptor according to an exemplary embodiment;

FIG. 2 is a schematic configuration diagram illustrating an example of an image forming apparatus according to the exemplary embodiment; and

FIG. 3 is a schematic configuration diagram illustrating another example of the image forming apparatus according to the exemplary embodiment.

### DETAILED DESCRIPTION

In the specification, when referring to the amount of each component in a composition, in a case where plural kinds of substances corresponding to each component in the composition, unless otherwise specified, the amount of each component means a total amount of the plural kinds of the substances.

Hereinafter, an exemplary embodiment of the invention will be described.

Electrophotographic Photoreceptor

An electrophotographic photoreceptor according to the exemplary embodiment includes a conductive substrate, an undercoating layer that is provided on the conductive substrate and contains a binder resin and metal oxide particles, and a photosensitive layer that is provided on the undercoating layer.

With respect to the undercoating layer, a ratio of an abundance of a metallic element to an abundance of a metallic element and a carbon element, which are obtained by subjecting a surface of the undercoating layer on which the photosensitive layer is provided to X-ray photoelectron spectroscopic analysis, is 3.9% or less.

Here, the ratio is provided from the abundance of the metallic element and the abundance of the carbon element, which are obtained from a peak area derived from the metallic element and a peak area derived from the carbon element, which are exhibited when a surface of the undercoating layer, on which the photosensitive layer is provided, is subjected to X-ray photoelectron spectroscopic analysis. The ratio is expressed as a percentage. Specifically, it will be described later.

From the viewpoint of improvement an image quality, the electrophotographic photoreceptor may, for example, be provided with the undercoating layer between the conductive substrate and the photosensitive layer. When the undercoating layer contains the binder resin and the metal oxide particles, the surface of the metal oxide particles may be coated with the binder resin in a non-uniform state. When a state of the binder resin with which the metal oxide particles are coated is in the non-uniform state, unevenness occurs in a conductive path in the undercoating layer. Therefore, a leakage current (hereinafter referred to as “leak current”) is likely to occur. When the leak current occurs, a color spot (for example, a black spot) occurs in an obtained image. In particular, when the leak current occurs at an interface between the undercoating layer and the photosensitive layer, a color spot is likely to occur. Furthermore, in a case of an image forming apparatus in which a transport speed of the recording medium is set to a low speed (for example, from 50 mm/sec to 200 mm/sec) (that is, a low process speed) and an image forming apparatus which is set to a high charged potential (for example, from −1,200 V to −600 V or less), the electrical partial pressure to the undercoating layer increases. Therefore, a color spot is more remarkably likely to occur.

On the other hand, in the electrophotographic photoreceptor according to the exemplary embodiment, a color spot is prevented by the configurations. A factor thereof is not certain but is presumed as shown below.

It is considered that since the ratio of the abundance of the metallic element to the abundance of the metallic element and the carbon element (hereinafter, simply referred to as an “abundance ratio of the metallic element”) with respect to a surface of the undercoating layer, on which the photosensitive layer is provided, which are detected by X-ray photoelectron spectroscopic analysis, is set to 3.9% or less, the surface of the metal oxide particles contained in the undercoating layer is coated with the binder resin in an almost uniform state. It is further considered that since the surface of the metal oxide particles contained in the undercoating layer is coated with the binder resin in an almost uniform state, unevenness of the conductive path is prevented, so that color spot is prevented in an obtained image. Furthermore, it is considered that, even in a case where the electrophotographic photoreceptor having the configuration is applied to an image forming apparatus with a low process speed that increases electrical partial pressure to the undercoating layer or an image forming apparatus that is set to a high charged potential to form an image, since a leakage current in the undercoating layer is prevented, a color spot is prevented.

Hereinafter, the electrophotographic photoreceptor according to the exemplary embodiment will be described in detail with reference to the drawings.

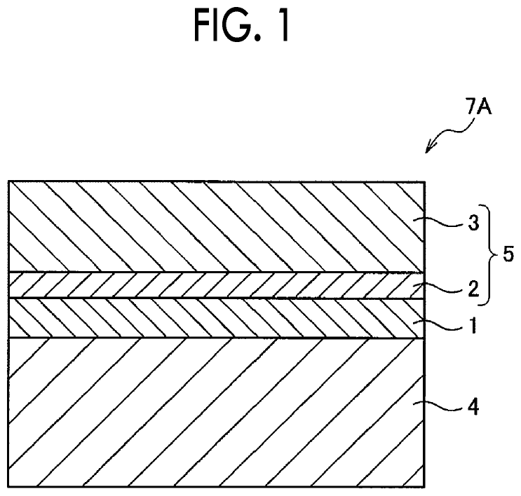

FIG. 1 is a schematic partial sectional diagram schematically illustrating an example of a layer configuration of the electrophotographic photoreceptor according to the exemplary embodiment.

An electrophotographic photoreceptor 7A shown in FIG. 1 has a structure in which an undercoating layer 1, a charge generation layer 2, and a charge transport layer 3 are stacked in this order on a conductive substrate 4. The charge generation layer 2 and the charge transport layer 3 form a photosensitive layer 5. In the electrophotographic photoreceptor 7A, the undercoating layer 1 contains a binder resin and metal oxide particles. With respect to the undercoating layer 1, a ratio of an abundance of a metallic element to an abundance of a metallic element and a carbon element, which are obtained by subjecting a surface of the undercoating layer 1, the surface being on the side of the photosensitive layer 5 (that is, a surface in contact with the charge generation layer 2), to X-ray photoelectron spectroscopic analysis, is 3.9% or less. The electrophotographic photoreceptor 7A may be provided with other layers as needed. Examples of the other layers include a protective layer provided on an outer peripheral surface of the charge transport layer 3. The electrophotographic photoreceptor according to the exemplary embodiment is not limited to the structure shown in FIG. 1, and the photosensitive layer may be a singlelayer type photosensitive layer.

Hereinafter, as an example of the electrophotographic photoreceptor according to the exemplary embodiment, each layer of the electrophotographic photoreceptor 7A shown in FIG. 1 will be described in detail. Descriptions will be given without reference numerals.

Conductive Substrate

Examples of the conductive substrate include a metal plate, a metal drum, and a metal belt, each including a metal (such as aluminum, copper, zinc, chromium, nickel, molybdenum, vanadium, indium, gold, and platinum) or an alloy (such as stainless steel). In addition, examples of the conductive substrate also include those obtained by applying, vapor-depositing, or laminating a conductive compound (for example, a conductive polymer, indium oxide, or the like), metal (for example, aluminum, palladium, gold, or the like), or an alloy onto paper, a resin film, or a belt. Here, “conductive” means that a volume resistivity is less than 10¹³ Ωcm.

In a case where the electrophotographic photoreceptor is used in a laser printer, the surface of the conductive substrate is preferably roughened to have a center line average roughness Ra of 0.04 μm to 0.5 μm for the purpose of preventing interference fringes which may be generated when irradiated with laser light. In a case of using non-interference light as a light source, although roughening for prevention of interference fringes is not particularly necessary, since the roughening prevents defects due to irregularities on the surface of the conductive substrate, it is suitable for longer life.

Examples of a surface-roughening method include wet honing performed by suspending an abrasive in water and spraying suspension on the conductive substrate, centerless grinding performed by pressing the conductive substrate against a rotating grindstone and performing continuous grinding processing, and anodic oxidation.

Examples of the surface-roughening method also include a method in which a conductive or semi-conductive powder is dispersed in a resin and the resultant is used to form a layer on the surface of the conductive substrate without roughening the surface of the conductive substrate, so that surface-roughening is performed by particles dispersed in the layer.

The surface roughening treatment by anodic oxidation is to form an oxide film on the surface of the conductive substrate by anodizing a conductive substrate made of metal (for example, aluminum) as an anode in an electrolyte solution. Examples of the electrolyte solution include a sulfuric acid solution and an oxalic acid solution. However, a porous anodic oxide film formed by the anodic oxidation is chemically active in the state as it is, is likely to be stained, and causes a large change in resistance depending on the environment. Therefore, the porous anodic oxide film is preferably subjected to a sealing treatment that fine pores of the oxide film are sealed by volume expansion due to hydration reaction in pressurized water vapor or boiling water (a metal salt such as nickel may be added), so that a more stable hydrated oxide is formed.

A thickness of the anodic oxide film is preferably from 0.3 μm to 15 μm. When the film thickness is within the above range, there is tendency that barrier properties against injection is exhibited, and there is tendency that rise of residual potential in repeated use is prevented.

The conductive substrate may also be subjected to a treatment with an acidic treatment solution or a boehmite treatment.

The treatment with the acidic treatment solution is carried out, for example, as follows. First, an acidic treatment liquid containing phosphoric acid, chromic acid, and hydrofluoric acid is prepared. A mixing ratio of the phosphoric acid, the chromic acid, and the hydrofluoric acid in the acidic treatment solution is, for example, from 10% by weight to 11% by weight of phosphoric acid, 3% by weight to and 5% by weight of chromic acid, and 0.5% by weight to 2% by weight of hydrofluoric acid, and a total concentration of these acids may be from 13.5% by weight to 18% by weight. The treatment temperature is preferably from 42° C. to 48° C. A film thickness of the film to be coated is preferably from 0.3 μm to 15 μm.

The boehmite treatment is carried out by, for example, immersing the conductive substrate in deionized water having a temperature of 90° C. to 100° C. for 5 minutes to 60 minutes, or contacting the conductive substrate to heated steam having a temperature of 90° C. to 120° C. for 5 minutes to 60 minutes. A film thickness of the coated film is preferably from 0.1 μm to 5 μm. The anodic oxidation may be further performed using an electrolyte solution having low film solubility such as adipic acid, boric acid, borate, phosphate, phthalate, maleate, benzoate, tartrate, and citrate.

Undercoating Layer

The undercoating layer is, for example, a layer containing metal oxide particles and a binder resin.

Examples of the metal oxide particles include metal oxide particles having a powder resistance (volume resistivity) of 10² Ωcm to 10¹¹ Ωcm.

Among these, examples of the metal oxide particles having the resistance value may include metal oxide particles such as tin oxide particles, titanium oxide particles, zinc oxide particles, and zirconium oxide particles. The metal oxide particles are preferably selected from the group consisting of zinc oxide particles, titanium oxide particles, and tin oxide particles, and the zinc oxide particles are particularly preferable.

A specific surface area of the metal oxide particles by a BET method may be, for example, 10 m²/g or more.

A volume average particle diameter of the metal oxide particles may be, for example, from 50 nm to 2,000 nm (more preferably from 60 nm to 1,000 nm).

From the viewpoint of preventing a color spot, a content of the metal oxide particles is preferably from 10% by weight to 85% by weight, and more preferably from 10% by weight to 70% by weight, with respect to the binder resin contained in the undercoating layer.

The metal oxide particles may be subjected to a surface treatment. Two or more kinds of the metal oxide particles, which are subjected to different surface treatments or have different particle diameters, may be used as a mixture thereof.

Examples of a surface treatment agent include a silane coupling agent, a titanate coupling agent, an aluminum coupling agent, and a surfactant. In particular, the silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-amino propylmethyldimethoxysilane, and N,N-bis(2-hydroxyethyl)-3-aminopropyltriethoxysilane, but are not limited thereto.

Two or more kinds of the silane coupling agents may be used as a mixture thereof. For example, the silane coupling agent having an amino group and another silane coupling agent may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method with the surface treatment agent may be any method as long as it is a known method, and a dry method or a wet method may be used.

An amount of the surface treatment agent for the treatment is preferably from 0.5% by weight to 10% by weight with respect to the metal oxide particles.

Here, the undercoating layer may contain an electron accepting compound (an acceptor compound) together with the metal oxide particles, from the viewpoint of improving long-term stability of electric characteristics and carrier blocking property.

Examples of the electron accepting compound include electron transport substances such as: quinone compounds such as chloranil and bromoanil; a tetracyanoquinodimethane compound; fluorenone compounds such as 2,4,7-trinitrofluorenone and 2,4,5,7-tetranitro-9-fluorenone; 2-(4-biphenyl)-5-(4-t-butylphenyl)-1,3,4-oxadiazole, 2,5-bis(4-naphthyl)-1,3,4-oxadiazole, oxadiazole compounds such as 2,5-bis(4-diethylaminophenyl)-1,3,4-oxadiazole; a xanthone compound; a thiophene compound; and diphenoquinone compounds such as 3,3′,5,5′-tetra-t-butyldiphenoquinone.

In particular, as the electron accepting compound, a compound having an anthraquinone structure is preferable. As the compound having an anthraquinone structure include a hydroxyanthraquinone compound, an aminoanthraquinone compound, and an aminohydroxyanthraquinone compound are preferable, and specifically, for example, anthraquinone, alizarin, quinizarin, anthrarufine, purpurin, and the like are preferable.

The electron accepting, compound is preferably an electron accepting compound having an anthraquinone skeleton, and more preferably an electron accepting compound having a hydroxyanthraquinone skeleton (anthraquinone skeleton having a hydroxyl group).

Specific examples of the electron accepting compound having the hydroxyanthraquinone skeleton include a compound represented by Formula (1).

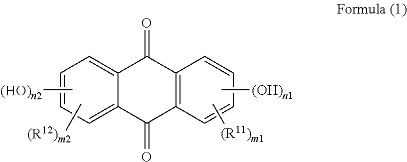

In Formula (1), n1 and n2 each independently represent an integer of 0 to 3. Here, at least one of n1 and n2 independently represents an integer of 1 to 3 (that is, n1 and n2 do not simultaneously represent 0). m1 and m2 each independently represent an integer of 0 or 1. R¹¹ and R¹² each independently represent an alkyl group having 1 to 10 carbon atoms or an alkoxy group having 1 to 10 carbon atoms.

As the electron accepting compound, a compound represented by formula (2) may also be used.

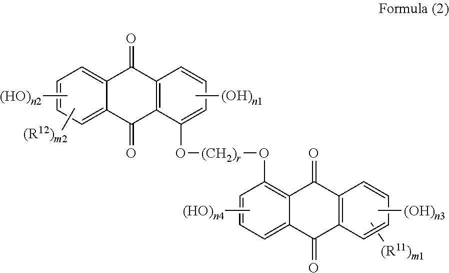

In Formula (2), n1, n2, n3, and n4 each independently represent an integer of 0 to 3. m1 and m2 each independently represent an integer of 0 or 1. At least one of n1 and n2 independently represents an integer of 1 to 3 (that is, n1 and n2 do not simultaneously represent 0). At least one of n3 and n4 independently represents an integer of 1 to 3 (that is, n3 and n4 do not simultaneously represent 0). r represents an integer of 2 to 10. R¹¹ and R¹² each independently represent an alkyl group having 1 to 10 carbon atoms or an alkoxy group having 1 to 10 carbon atoms.

In Formulas (1) and (2), the alkyl group having 1 to 10 carbon atoms represented by R¹¹ and R¹² may be linear or branched, and examples thereof include a methyl group, an ethyl group, a propyl group, and an isopropyl group. The alkyl, group having 1 to 10 carbon atoms is preferably an alkyl group having 1 to 8 carbon atoms, and more preferably an alkyl group having 1 to 6 carbon atoms.

The alkoxy group (alkoxyl group) having 1 to 10 carbon atoms represented by R¹¹ and R¹² may be linear or branched, and examples thereof include a methoxy group, an ethoxy group, a propoxy group, and an isopropoxy group. The alkoxy group having 1 to 10 carbon atoms is preferably an alkoxyl group having 1 to 8 carbon atoms, and more preferably an alkoxyl group having 1 to 6 carbon atoms.

Specific examples of the electron accepting compound will be shown below, but are not limited thereto.

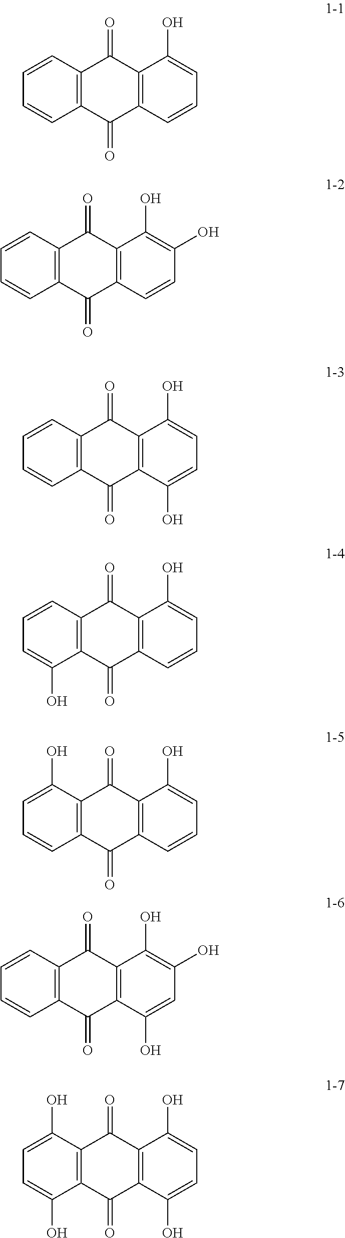

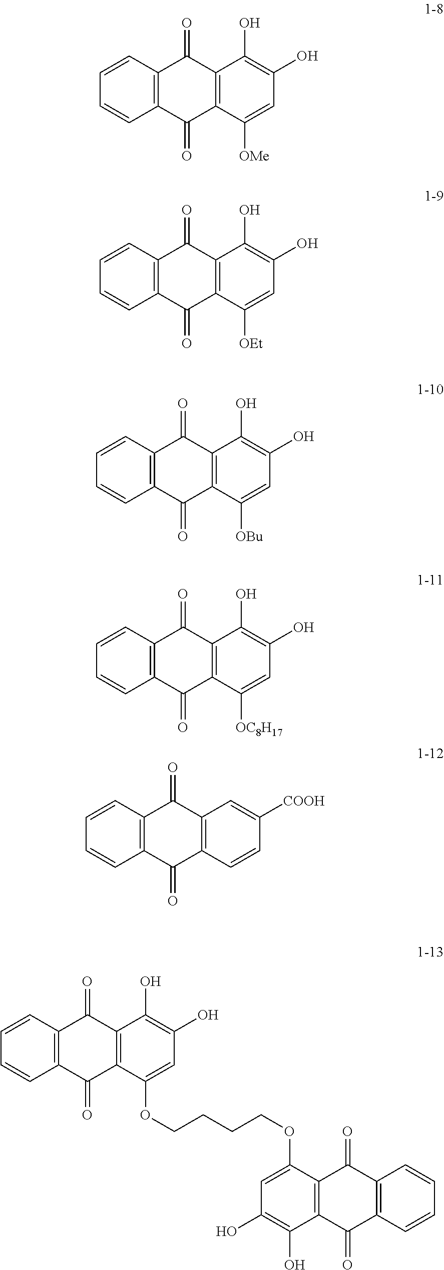

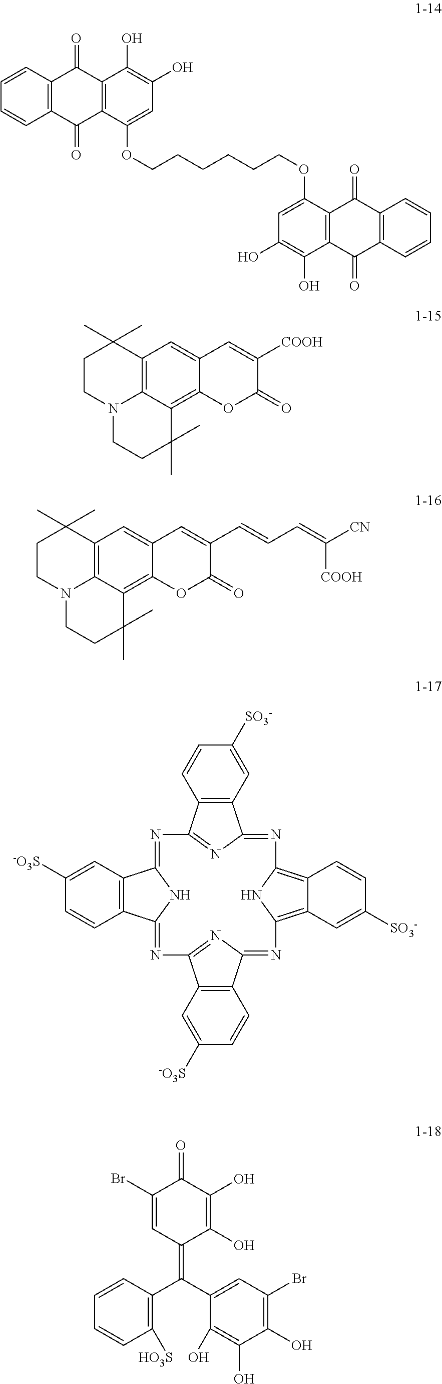

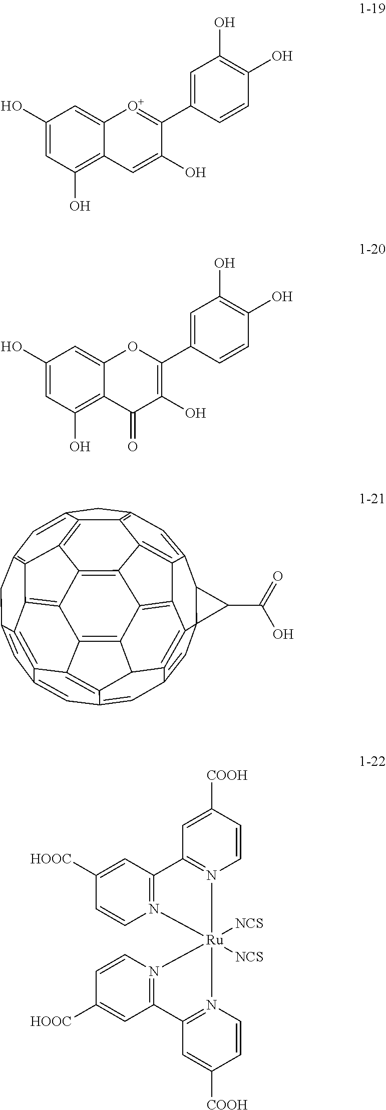

The electron accepting compound may be contained by being dispersed in the undercoating layer together with the metal oxide particles or may be contained in a state of being attached to the surfaces of the metal oxide particles.

Examples of a method of attaching the electron accepting compound to the surfaces of the metal oxide particles include a dry method or a wet method.

The dry method is, for example, a method in which while stirring metal oxide particles in a mixer or the like having a large shear force, an electron accepting compound is dropped directly therein or an organic solvent containing an electron accepting compound dissolved therein, together with dry air or nitrogen gas, is sprayed therein, so as to attach the electron accepting compound to the surfaces of the metal oxide particles. The dropping or spraying the electron accepting compound may be carried out at a temperature equal to or lower than a boiling point of the solvent. After dropping or spraying the electron accepting compound, baking may further be carried out at 100° C. or higher. Baking is not particularly limited as long as the baking is carried out at an arbitrary temperature and an arbitrary time as long as electrophotographic characteristics are obtained.

The wet method is, for example, a method in which an electron accepting compound is added while dispersing metal oxide particles in a solvent with stirring, ultrasonic wave, sand mill, attritor, ball mill, or the like, and is stirred or dispersed, and then the solvent is removed to attach the electron accepting compound to the surfaces of the metal oxide particles. In the solvent removal method, the solvent is removed, for example, by filtration or distillation. After removing the solvent, baking may further be carried out at 100° C. or higher. Baking is not particularly limited as long as the baking is carried out at an arbitrary temperature and an arbitrary time as long as electrophotographic characteristics are obtained. In the wet method, moisture contained in the metal oxide particles may be removed before adding the electron accepting compound. Examples of this method include a method of removing the moisture while stirring and heating in a solvent, and a method of removing the moisture by azeotropic distillation with a solvent.

The attachment of the electron accepting compound may be carried out before or after the metal oxide particles are subjected to the surface treatment with the surface treatment agent. Also, the attachment of the electron accepting compound and the surface treatment with the surface treatment agent may be carried out at the same time.

A content of the electron accepting compound may be, for example, from 0.01% by weight to 20% by weight, and is preferably from 0.01% by weight to 10% by weight with respect to the metal oxide particles.

Examples of the binder resin used for the undercoating layer include known polymer compounds such as acetal resins (such as polyvinyl butyral), polyvinyl alcohol resin, polyvinyl acetal resin, casein resin, polyamide resin, cellulose resin, gelatin, polyurethane resin, polyester resin, unsaturated polyester resin, methacrylic resin, acrylic resin, polyvinyl chloride resin, polyvinyl acetate resin, vinyl chloride-vinyl acetate-maleic anhydride resin, silicone resin, silicone-alkyd resin, urea resin, phenol resin, phenol-formaldehyde resin, melamine resin, urethane resin, alkyd resin, and epoxy resin; a zirconium chelate compound; a titanium chelate compound; an aluminum chelate compound; a titanium alkoxide compound; an organic titanium compound; and a known material such as a silane coupling agent.

Examples of the binder resin used for the undercoating layer also include a charge transporting resin having a charge transporting group and conductive resin (such as polyaniline).

Among these, as the binder resin used for the undercoating layer, a resin which is insoluble in a coating solvent of the upper layer. In particular, a resin obtained by the reaction between a curing agent and at least one selected from the group consisting of thermosetting resin such as urea resin, phenol resin, phenol-formaldehyde resin, melamine resin, urethane resin, unsaturated polyester resin, alkyd resin, and epoxy resin; polyamide resin, polyester resin, polyether resin, methacrylic resin, acrylic resin, polyvinyl alcohol resin, and polyvinyl acetal resin is preferable. Among these, as the binder resin, at least one selected from the group consisting of phenol resin, melamine resin, guanamine resin, and urethane resin is more preferable and at least one selected from the group consisting of phenol resin and urethane resin is more preferable.

In a case where two or more of these binder resins are used in combination, a mixing ratio thereof is set as needed.

The undercoating layer may contain various additives for improving electrical properties, environmental stability, or image quality.

Examples of the additives include known materials such as an electron transporting pigment such as polycondensation type pigment and azo type pigment, a zirconium chelate compound, a titanium chelate compound, an aluminum chelate compound, a titanium alkoxide compound, an organic titanium compound, and a silane coupling agent. The silane coupling agent is used for a surface treatment of the metal oxide particles as described above, but may be further added to the undercoating layer as additives.

Examples of the silane coupling agent as additives include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compound include tetraisopropyl titanate, tetra-n-butyl titanate, butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxy aluminum diisopropylate, aluminum butyrate, diethyl acetoacetate aluminum diisopropylate, and aluminum tris(ethyl acetoacetate).

These additives may be used alone, or as a mixture or polycondensate of plural compounds.

The undercoating layer may have a Vickers hardness of 35 or higher.

In order to prevent a moire fringe, surface roughness (ten-point average roughness) of the undercoating layer may be adjusted from 1/(4n) (n is a refractive index of an upper layer) of the exposure laser wavelength λ to ½ thereof.

In order to adjust the surface roughness, the resin particles or the like may be added to the undercoating layer. Examples of the resin particles include silicone resin particles and crosslinked polymethylmethacrylate resin particles. Further, in order to adjust the surface roughness, the surface of the undercoating layer may be polished. Examples of a polishing method include buffing, sandblasting treatment, wet honing, and grinding treatment.

Formation of the undercoating layer is not particularly limited and a known forming method is used. For example, a coating film is formed with an undercoating layer-forming coating liquid obtained by adding the above components to a solvent, and the coating film is dried, by heating as needed, to form the undercoating layer.

Examples of the solvent for preparing the undercoating layer-forming coating liquid include known organic solvents such as alcohol solvent, aromatic hydrocarbon solvent, halogenated hydrocarbon solvent, ketone solvent, ketone alcohol solvent, ether solvent, and ester solvent.

Specific examples of these solvents include usual organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing metal oxide particles in preparing the undercoating layer-forming coating liquid include known methods such as a roll mill, a ball mill, a vibration ball mill, an attritor, a sand mill, a colloid mill, and a paint shaker.

Examples of a method for applying the undercoating layer-forming coating liquid onto the conductive substrate include ordinary methods such as a blade coating method, a wire bar coating method, a spray coating method, a dipping coating method, a bead coating method, an air knife coating method, and a curtain coating method.

The ratio of the abundance of the metallic element to the abundance of the metallic element and the carbon element, which are obtained by subjecting a surface of the undercoating layer, on which the photosensitive layer is provided, to X-ray photoelectron spectroscopic analysis, is 3.9% or less. From the viewpoint of preventing a color spot, the ratio is preferably less than 3.8%, more preferably 0.3% or more and less than 3.8%.

The ratio (that is, the abundance ratio of the metallic element) obtained from the abundance of the metallic element and the abundance of the carbon element, obtained by subjecting a surface of the undercoating layer, on which the photosensitive layer is provided, to X-ray photoelectron spectroscopic analysis (XPS measurement) is measured as follows.

(1) First, the undercoating layer is exposed by removing a layer (such as a photosensitive layer) formed on an outer peripheral surface of the undercoating layer in the electrophotographic photoreceptor such that the surface of the undercoating layer on which the photosensitive layer is provided may be subjected to XPS measurement. Examples of a removing method include a method of removing with a cutter or the like and a method of removing by performing dissolution with a solvent or the like.

(2) Next, the undercoating layer is cut into a size of 2.0 cm×2.0 cm, and the surface of the undercoating layer on which the photosensitive layer is provided is measured by XPS under the following conditions.

Conditions for XPS Measurement

X-ray photoelectron spectrometer: PHI 5000 VersaProbe manufactured by ULVAC-PHI, INCORPORATED.

X-ray: 100 μmΦ Measurement area: 300 μm square

(3) Next, a peak area derived from the metallic element is determined from a measurement result obtained in (2), and the peak area is used as the abundance of the metallic element. Also, a peak area derived from the carbon element is determined from a measurement result obtained in (2), and the peak area is used as the abundance of the carbon element. Here, the peak area derived from the metallic element represents a peak area derived from the metallic element contained in the metal oxide particles.

(4) Next, an abundance ratio of the metallic element is determined from the obtained abundance of the metallic element and the obtained abundance of the carbon element, using Equation A.

Abundance ratio (%) of metallic element={(Peak area derived from metallic element)/((Peak area derived from metallic element)+(Peak area derived from carbon element))}×100 Equation A:

(5) Operations of the above methods (1) to (4) are performed on three different locations on the surface of the undercoating layer, and an arithmetic average value of the obtained abundance ratio of the metallic elements is defined as the abundance ratio of the metallic elements.

In a case where peaks derived from plural metallic elements such as an M1 element and an M2 element are observed and it may be determined that plural metallic elements are included, the sum of the areas of the plurality of metallic elements (Peak area derived from the M1 element+Peak area derived from the M2 element) is defined as the peak area of the metallic element.

As a method of setting the abundance ratio of the metallic element, detected by the X-ray photoelectron spectroscopic analysis on the surface of the undercoating layer on which the photosensitive layer is provided, within the above range, for example, in a preparation step of an undercoating layer coating liquid, the abundance ratio may be controlled by adjusting dispersing time after mixing the binder resin and the metal oxide particles or adjusting the content of the metal oxide particles with respect to the binder resin. In a case of adjusting the dispersing time to disperse, it is preferable that the dispersing time is longer (for example, 4.1 hours or longer). In a case of adjusting the content of the metal oxide particles, it is preferable to set to an appropriate amount (for example, 10% by weight or more and less than 85%).

A film thickness of the undercoating layer is set to be preferably 15 μm or more, and more preferably from 20 μm to 50 μm.

Intermediate Layer

Although not shown, an intermediate layer may further be provided between the undercoating layer and the photosensitive layer.

The intermediate layer is, for example, a layer containing a resin. Examples of the resin used for the intermediate layer include polymer compounds such as acetal resin (such as polyvinyl butyral), polyvinyl alcohol resin, polyvinyl acetal resin, casein resin, polyamide resin, cellulose resin, gelatin, polyurethane resin, polyester resin, methacrylic resin, acrylic resin, polyvinyl chloride resin, polyvinyl acetate resin, vinyl chloride-vinyl acetate-maleic anhydride resin, silicone resin, silicone-alkyd resin, phenol-formaldehyde resin, and melamine resin.

The intermediate layer may be a layer containing an organometallic compound. Examples of the organometallic compound used for the intermediate layer include an organometallic compound containing a metal atom such as zirconium, titanium, aluminum, manganese, and silicon.

These compounds used for the intermediate layer may be used alone, or as a mixture or a polycondensate of plural compounds.

Among these, the intermediate layer is preferably a layer containing the organometallic compound having a zirconium atom or a silicon atom.

Formation of the undercoating layer is not particularly limited and a known forming method is used. For example, a coating film of an undercoating layer-forming coating liquid obtained by adding the above components to a solvent is formed, and the coating film is dried to form the undercoating layer by heating as needed.

As a coating method by which the intermediate layer is formed, ordinary methods such as a dipping coating method, an extrusion coating method, a wire bar coating method, a spray coating method, a blade coating method, a knife coating method, and a curtain coating method are used.

A film thickness of the intermediate layer is preferably set to, for example, 0.1 μm to 3 μm. The intermediate layer may also be used as the undercoating layer.

Charge Generation Layer

The charge generation layer is, for example, a layer containing a charge generation material and binder resin. Further, the charge generation layer may be a deposition layer of a charge generation material. The deposition layer of the charge generation material is suitable for a case of using an incoherent light source such as a light emitting diode (LED) or an organic electro-luminescence (EL) image array.

Examples of the charge generation material include azo pigments such as bisazo and trisazo; a condensed ring aromatic pigment such as dibromoanthanthrone; a perylene pigment; a pyrrolopyrrole pigment; a phthalocyanine pigment; zinc oxide; and trigonal selenium.

Among these materials, in order to cope with laser exposure in the near infrared region, it is preferable to use a metal phthalocyanine pigment or a metal-free phthalocyanine pigment, as the charge generation material. Specifically, for example, hydroxygallium phthalocyanine; chlorogallium phthalocyanine; dichlorotin phthalocyanine; and titanyl phthalocyanine are more preferable.

On the other hand, in order to cope with laser exposure in the near ultraviolet region, as the charge generation material, a condensed aromatic pigment such as dibromoanthanthrone; a thioindigo pigment; a porphyrazine compound; zinc oxide; trigonal selenium; a disazo compound; and a bisazo pigment are preferable.

Also, in a case of using an incoherent light source having an emission center wavelength of 450 nm to 780 nm, such as an LED or an organic EL image array, the above charge generation material may be used. However, from the viewpoint of resolution, when using a thin film of 20 μm or less as the photosensitive layer, the electric field intensity in the photosensitive layer increases, and charge reduction due to charge injection from the substrate and image defect referred to as a so-called black spot tend to occur. The tendency is remarkable when using a charge generation material which is likely to cause dark current in a p-type semiconductor such as trigonal selenium or a phthalocyanine pigment.

On the contrary, when using an n-type semiconductor such as a condensed ring aromatic pigment, a perylene pigment, and an azo pigment, as the charge generation material, it is difficult to generate a dark current and, even in a thin film, the image defect called a black spot is prevented. Examples of the n-type charge generation material include compounds (CG-1) to (CG-27) described in paragraphs [0288] to [0291] of JP-A-2012-155282, but are not limited thereto.

n-Type is determined depending on a polarity of flowing photocurrent by using a normally used time-of-flight method, and a type in which the photocurrent is easy to flow using electrons rather than holes as carriers is determined as the n-type.

The binder resin used for the charge generation layer is selected from a wide range of insulating resins. In addition, the binder resin may be selected from organic photoconductive polymers such as poly-N-vinylcarbazole, polyvinylanthracene, polyvinylpyrene, and polysilane.

Examples of the binder resin include polyvinyl butyral resin, polyarylate resin (such as polycondensate of bisphenols and aromatic dicarboxylic acid), polycarbonate resin, polyester resin, phenoxy resin, vinyl chloride-vinyl acetate copolymer, polyamide resin, acrylic resin, polyacrylamide resin, polyvinyl pyridine resin, cellulose resin, urethane resin, epoxy resin, casein, polyvinyl alcohol resin, and polyvinyl pyrrolidone resin. Here, “conductive” means that the volume resistivity is 10¹³ Ωcm or more.

One kind of these binder resins is used alone or two or more kinds thereof are used as a mixture thereof.

A mixing ratio of the charge generation material and the binder resin is preferably from 10:1 to 1:10 in terms of weight ratio.

The charge generation layer may also contain other known additives.

Formation of the charge generation layer is not particularly limited and a known forming method is used. For example, a coating film of a charge generation layer-forming coating liquid obtained by adding the above components to a solvent is formed, and the coating film is dried to form the charge generation layer by heating as needed. The formation of the charge generation layer may be carried out by vapor deposition of the charge generation material. Formation of the charge generation layer by the vapor deposition is particularly suitable for a case of using a condensed ring aromatic pigment or a perylene pigment as the charge generation material.

Examples of a solvent for preparing the charge generation layer-forming coating liquid include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. One kind of the solvents is used alone and two or more kinds thereof are used as a mixture thereof.

In a method for dispersing particles (for example, charge generation material) in the charge generation layer-forming coating liquid, for example, a media dispersing machine such as a ball mill, a vibration ball mill, an attritor, a sand mill, and a horizontal sand mill or a media-less dispersing machine such as a stirrer, an ultrasonic dispersing machine, a roll mill, and a high-pressure homogenizer is used. Examples of the high-pressure homogenizer include a collision type in which dispersing is performed by a liquid-liquid collision or a liquid-wall collision in a high pressure state, or a penetration type in which dispersing is performed by penetrating a fine flow path in a high pressure state.

When dispersing is performed, it is effective to set the average particle diameter of the charge generation material in the charge generation layer-forming coating liquid to 0.5 μm or less, preferably 0.3 μm or less, and more preferably 0.15 μm or less.

Examples of a method for coating the undercoating layer (or an intermediate layer) with the charge generation layer-forming coating liquid include ordinary methods such as a blade coating method, a wire bar coating method, a spray coating method, a dipping, coating method, a bead coating method, an air knife coating method, and a curtain coating method.

A film thickness of the charge generation layer is set to be preferably from 0.1 μm to 5.0 μm, and more preferably from 0.2 μM to 2.0 μm.

Charge Transport Layer

The charge transport layer is, for example, a layer containing a charge transporting, material and a binder resin. The charge transport layer may be a layer containing a polymeric charge transporting material.

Examples of the charge transporting material include electron transport compounds such as: quinone compounds such as p-benzoquinone, chloranil, bromanil, and anthraquinone; a tetracyanoquinodimethane compound; a fluorenone compound such as 2,4,7-trinitrofluorenone; a xanthone compound; a benzophenone compound; a cyanovinyl compound; and an ethylene compound. Examples of the charge transporting material also include hole transporting compounds such as a triarylamine compound, a benzidine compound, an arylalkane compound, an aryl-substituted ethylene compound, a stilbene compound, an anthracene compound, and a hydrazone compound. These charge transporting materials may be used alone or in combination of two or more thereof, but are not limited thereto.

As the charge transporting material, from the viewpoint of charge mobility, a triarylamine derivative represented by the following Formula (a-1) and a benzidine derivative represented by the following Formula (a-2) are preferable.

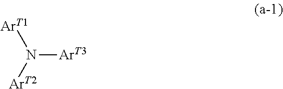

In Formula (a-1), Ar^{T1}, Ar^{T2}, and AR^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each of the above groups include a halogen atom, an alkyl group having 1 to 5 carbon atoms, and an alkoxy group having 1 to 5 carbon atoms. Examples of the substituent of each of the above groups also include a substituted amino group substituted with an alkyl group having 1 to 3 carbon atoms.

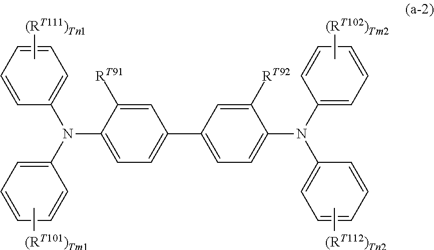

In Formula (a-2), R^{T91}, and R^{T92} each independently represent a hydrogen atom, a halogen atom, an alkyl group having 1 to 5 carbon atoms, or an alkoxy group having 1 to 5 carbon atoms. T¹⁰¹, R^{T102}, R^{T111}, and R^{T112} each independently represent a halogen atom, an alkyl group having 1 to 5 carbon atoms, an alkoxy group having 1 to 5 carbon atoms, an amino group having 1 or 2 carbon atoms substituted with an alkyl group, a substituted or unsubstituted aryl group, —C(R^{T12})═C(R^{T13})(R^{T14}), or —CH═CH—CH═C(R^{T15})(R^{T16}). R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 to 2.

Examples of the substituent of each of the above groups include a halogen atom, an alkyl group having 1 to 5 carbon atoms, and an alkoxy group having 1 to 5 carbon atoms. Examples of the substituent of each of the above groups also include a substituted amino group substituted with an alkyl group having 1 to 3 carbon atoms.

Among the triarylamine derivative represented by Formula (a-1) and the benzidine derivative represented by Formula (a-2), from the viewpoint of charge mobility, a triarylamine derivative having “—C₆H₄—CH═CH—CH═C(R^{T7})(R^{T8})” and a benzidine derivative having “—CH═CH—CH═C(R^{T15})(R^{T16})” are particularly preferable.

As the polymeric charge transporting material, known materials having charge transporting ability, such as poly-N-vinylcarbazole and polysilane are used. In particular, polyester-based polymeric charge transporting materials are particularly preferable. The polymer charge transporting material may be used alone or may be used in combination with the binder resin.

Examples of the binder resin used for the charge transport layer include polycarbonate resin, polyester resin, polyarylate resin, methacrylic resin, acrylic resin, polyvinyl chloride resin, polyvinylidene chloride resin, polystyrene resin, polyvinyl acetate resin, styrene-butadiene copolymer, vinylidene chloride-acrylonitrile copolymer, vinyl chloride-vinyl acetate copolymer, vinyl chloride-vinyl acetate-maleic anhydride copolymer, silicone resin, silicone alkyd resin, phenol-formaldehyde resin, styrene-alkyd resin, poly-N-vinylcarbazole, and polysilane. Among these resins, as the binder resin, the polycarbonate resin or the polyarylate resin is preferable. One kind of these binder resins is used alone or two or more kinds thereof are used.

A mixing ratio of the charge transporting material and the binder resin is preferably from 10:1 to 1:5 in terms of weight ratio.

The charge transport layer may also contain other known additives.

Formation of the charge transport layer is not particularly limited and a known forming method is used. For example, a coating film of a charge transport layer-forming coating liquid obtained by adding the above components to a solvent is formed, and the coating film is dried to form the charge transport layer by heating as needed.

Examples of a solvent for preparing the charge transport layer-forming coating liquid include usual organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. One kind of the solvents is used alone and two or more kinds thereof are used as a mixture thereof.

Examples of an applying method used when applying the charge transport layer-forming coating liquid onto the charge generation layer include ordinary methods such as a blade coating method, a wire bar coating method, a spray coating method, a dipping coating method, a bead coating method, an air knife coating method, and a curtain coating method.

A film thickness of the charge transport layer is set to be preferably from 5 μm to 50 μm, and more preferably from 10 μm to 30 μm.

Protective Layer

The protective layer is provided on the photosensitive layer as needed. The protective layer is provided, for example, to prevent the photosensitive layer from chemically changing at the time of charging and to further improve the mechanical strength of the photosensitive layer.

Therefore, a layer configured by a cured film (crosslinked film) may be applied to the protective layer. Examples of the layer include a layer shown in the following 1) or 2).

1) A layer configured by a cured film of a composition containing a reactive group-containing charge transporting material having a reactive group and a charge transporting skeleton in the same molecule (that is, a layer containing a polymer or crosslinked member of the reactive group-containing charge transporting material)

2) A layer configured by a cured film of a composition containing a non-reactive charge transporting material and a reactive group-containing non-charge transporting material having a reactive group without having a charge transporting skeleton (that is, a layer containing a non-reactive charge transporting material and a polymer or a crosslinked member of the reactive group-containing non-charge transporting material)

Examples of the reactive group of the reactive group-containing charge transporting material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as it is a functional group capable of radical polymerization, and is, for example, a functional group having a group containing at least a carbon double bond. Specific examples thereof include a group containing at least one selected from a vinyl group, a vinyl ether group, a vinyl thioether group, a styryl group (vinyl phenyl group), an acryloyl group, a methacryloyl group, and derivatives thereof. Among these, from the viewpoint of excellent reactivity, as the chain polymerizable group, a group containing at least one selected from the vinyl group, the styryl group (vinylphenyl group), the acryloyl group, the methacryloyl group, and derivatives thereof is preferable.

The charge transporting skeleton of the reactive group-containing charge transporting material is not particularly limited as long as it is a known structure in an electrophotographic photoreceptor, and examples thereof include skeleton derived from a nitrogen-containing hole transport compound such as a triarylamine compound, a benzidine compound, and a hydrazone compound, in which the skeleton has a structure conjugated with a nitrogen atom. Among these, a triarylamine skeleton is preferable.

The reactive group-containing charge transporting material having a reactive group and a charge transporting skeleton, the non-reactive charge transporting material, and the reactive group-containing non-charge transporting material may be selected from known materials.

The protective layer may also contain other known additives.

Formation of the protective layer is not particularly limited and a known forming method is used. For example, a coating film of a protective layer-forming coating liquid obtained by adding the above components to a solvent is formed, and the coating film is dried to form the protective layer by a curing treatment such as heating as needed.

Examples of the solvent for preparing the protective layer-forming coating liquid include aromatic solvents such as toluene and xylene; ketone solvents such as methyl ethyl ketone, methyl isobutyl ketone, and cyclohexanone; ester solvents such as ethyl acetate and butyl acetate; ether solvents such as tetrahydrofuran and dioxane; cellosolve solvents such as ethylene glycol monomethyl ether; and alcohol solvents such as isopropyl alcohol and butanol. One kind of the solvents is used alone and two or more kinds thereof are used as a mixture thereof.

The protective layer-forming coating liquid may be a solventless coating liquid.

Examples of a method of applying the protective layer-forming coating liquid onto photosensitive layer (for example, charge transport layer) include ordinary methods such as a dipping coating method, an extrusion coating method, a wire bar coating method, a spray coating method, a blade coating method, a knife coating method, and a curtain coating method.

A film thickness of the protective layer is set to be preferably from 1 μm to 20 μm, and more preferably from 2 μm to 10 μm.

Singlelayer Type Photosensitive Layer

The singlelayer type photosensitive layer (charge generation/transport layer) is, for example, a layer containing a charge generation material and a charge transporting material, and further containing a binder resin and other known additives, as needed. These materials are the same as those described for the charge generation layer and the charge transport layer.

Then, a content of the charge generation material in the singlelayer type photosensitive layer may be from 0.1% by weight to 10% by weight, and is preferably from 0.8% by weight to 5% by weight, with respect to the total solid content. In addition, a content of the charge transporting material in the singlelayer type photosensitive layer may be from 5% by weight to 50% by weight, with respect to the total solid content.

The method of forming the singlelayer type photosensitive layer is the same as the method of forming the charge generation layer and the charge transport layer.

A film thickness of the singlelayer type photosensitive layer may be from 5 μm to 50 μm, and is preferably from 10 μm to 40 μm.

Image Forming Apparatus and Process Cartridge

An image forming apparatus according to the exemplary embodiment includes: an electrophotographic photoreceptor; a charging unit that charges a surface of the electrophotographic photoreceptor; an electrostatic latent image forming unit that forms an electrostatic latent image on the charged surface of the electrophotographic photoreceptor; a developing unit that develops the electrostatic latent image formed on the surface of the electrophotographic photoreceptor with a developer including toner to form a toner image; and a transfer unit that transfers the toner image onto a surface of a recording medium. As the electrophotographic photoreceptor, the electrophotographic photoreceptor according to the exemplary embodiment is adopted.

In addition, in the image forming apparatus according to the exemplary embodiment, a transport speed of the recording medium may be set to be from 50 mm/sec to 200 mm/sec (preferably from 100 mm/sec to 200 mm/sec).

Furthermore, in the image forming apparatus according to the exemplary embodiment, the charged potential of the surface of the electrophotographic photoreceptor after being charged by the charging unit may be set to be from −1,200 V to −600 V (preferably from −1,000 V to −600 V). The charged potential of the surface of the electrophotographic photoreceptor after being charged by the charging unit represents a surface potential of the photoreceptor after being charged by the charging unit, and represents a surface potential before being exposed by the exposure unit after being charged by the charging unit.

The image forming apparatus according to the exemplary embodiment may include a controller that performs at least one of control of making the transport speed of the recording medium within the above range and control of obtaining the charged potential of the surface of the electrophotographic photoreceptor after being charged by the charging unit.

As the image forming apparatus according to the exemplary embodiment, known image forming apparatuses are adopted. Examples thereof include an apparatus including fixing unit that fixes a transferred toner image to a surface of a recording medium; a direct transfer type apparatus that directly transfers a toner image formed on a surface of an electrophotographic photoreceptor to a recording medium; an intermediate transfer type apparatus that firstly transfers a toner image formed on a surface of an electrophotographic photoreceptor to a surface of an intermediate transfer member and secondarily transfers the toner image transferred to the surface of the intermediate transfer member onto a surface of a recording medium; an apparatus including a cleaning unit that cleans a surface of the electrophotographic photoreceptor after the transfer of the toner image and before charging; an apparatus including an erasing unit that irradiates a surface of the electrophotographic photoreceptor after the transfer of a toner image and before charging, with antistatic electricity to erase electricity; and an apparatus including an electrophotographic photoreceptor heating unit that raise a temperature of an electrophotographic photoreceptor and reduces a relative temperature.

In a case of the intermediate transfer type apparatus, the transfer unit adopts, for example, a configuration including an intermediate transfer member in which a toner image is transferred on a surface thereof, a first transfer unit that firstly transfers the toner image formed on the surface of the electrophotographic photoreceptor to a surface of the intermediate transfer member, and a second transfer unit that secondarily transfers the toner image transferred to the surface of the intermediate transfer member to a surface of a recording medium.

The image forming apparatus according to the exemplary embodiment may be any of a dry developing type image forming apparatus or a wet developing type (a developing type using a liquid developer) image forming apparatus.

In the image forming apparatus according to the exemplary embodiment, for example, a portion having an electrophotographic photoreceptor may have a cartridge structure (process cartridge) which is detachable from the image forming apparatus. As the process cartridge, for example, a process cartridge including the electrophotographic photoreceptor according to the exemplary embodiment is suitably used. In the process cartridge may further include, for example, at least one selected from the group consisting of a charging unit, an electrostatic latent image forming unit, a developing unit, and a transfer unit, in addition to the electrophotographic photoreceptor.

Hereinafter, an example of the image forming apparatus according to the exemplary embodiment will be shown, but the image forming apparatus is not limited thereto. A major part shown in the figure will be described, and descriptions for the other parts will be omitted.

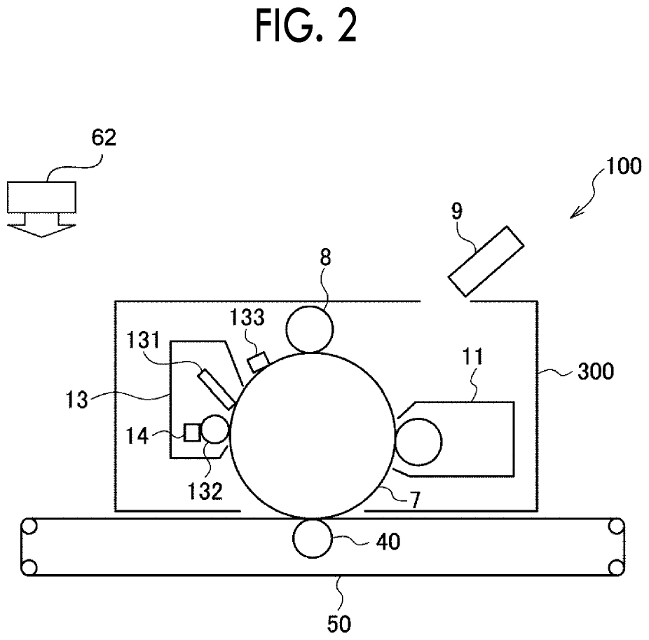

FIG. 2 is a schematic configuration diagram illustrating an example of the image forming apparatus according to the exemplary embodiment.

As shown in FIG. 2, the image forming apparatus 100 according to the exemplary embodiment includes a process cartridge 300 having an electrophotographic photoreceptor 7, an exposure unit 9 (an example of an electrostatic latent image forming unit), a transfer unit 40 (first transfer unit), and an intermediate transfer member 50. In the image forming apparatus 100, the exposure unit 9 is disposed at a position at which the electrophotographic photoreceptor 7 may be exposed from an opening of the process cartridge 300, the transfer unit 40 is disposed at a position facing the electrophotographic photoreceptor 7 via the intermediate transfer member 50, and the intermediate transfer member 50 is disposed so that a part thereof is in contact with the electrophotographic photoreceptor 7. Although not shown, the image forming apparatus 100 further includes a secondary transfer unit that transfers the toner image transferred to the intermediate transfer member 50 to a recording medium (for example, paper). The intermediate transfer member 50, the transfer unit 40 (first transfer unit), and the secondary transfer unit (not shown) correspond to examples of the transfer unit. In addition, the image forming apparatus 100 shown in FIG. 2 further includes a control unit 62 (an example of the controller) that is connected to each apparatus and each member of the image forming apparatus 100 and controls an operation of each apparatus and each member.

The process cartridge 300 in FIG. 2 includes the electrophotographic photoreceptor 7, a charging unit 8 (an example of the charging unit), a developing unit 11 (an example of the developing unit), and a cleaning unit 13 (an example of the cleaning unit), which are in a housing and are integrally supported. The cleaning unit 13 has a cleaning blade (an example of a cleaning member) 131. The cleaning blade 131 is disposed so as to contact with a surface of the electrophotographic photoreceptor 7. The cleaning member may be a conductive or insulating fibrous member, instead of an aspect of the cleaning blade 131. The conductive or insulating fibrous member may be used alone or in combination with the cleaning blade 131.

In FIG. 2, as the image forming apparatus, an example of including a fibrous member 132 (roll-shaped) that supplies a lubricant 14 to the surface of the electrophotographic photoreceptor 7 and a fibrous member 133 (flat brush shaped) that assists cleaning is shown, but these are disposed as needed.

Hereinafter, a configuration of the image forming apparatus according to the exemplary embodiment will be described.

Charging Unit

As the charging unit 8, for example, a contact type charging member using a conductive or semiconductive charging roller, a charging brush, a charging film, a charging rubber blade, a charging tube, or the like is used. In addition, a non-contact type roller charging member, a charging member known as it is such as a scorotron charging member or a corotron charging member using corona discharge, or the like is also used.

For example, the charging unit 8 is electrically connected to the control unit 62 provided in the image forming apparatus 100, and is driven and controlled by the control unit 62 to apply a charging voltage to the charging member of the charging unit 8. The charging unit to which a charging voltage is applied from a voltage application unit (not shown) charges the electrophotographic photoreceptor 7 to obtain a charged potential corresponding to the applied charging voltage. The surface of the electrophotographic photoreceptor 7 is charged, by adjusting the charging voltage applied from the voltage application unit (not shown) so that the charged potential after being charged by the charging unit is, for example, to be from −1200 V to −600 V.

Exposure Unit

Examples of the exposure unit 9 include an optical system unit the exposes the surface of the electrophotographic photoreceptor 7 to light such as semiconductor laser light, LED light, liquid crystal shutter light according to an image data. A wavelength of the light source is within a spectral sensitivity range of the electrophotographic photoreceptor. As a wavelength of the semiconductor laser, near infrared having an emission wavelength near 780 nm is mostly used. However, the wavelength is not limited thereto, and an emission wavelength laser of 600 nm band or a laser having an emission wavelength from 400 nm to 450 nm as blue laser may also be used. In addition, a surface emitting type laser light source capable of outputting multiple beams is also effective for forming a color image.

Developing Unit

Examples of the developing unit 11 include a general developing unit that develops an image by contacting or non-contacting with a developer. The developing unit 11 is not particularly limited as long as it has the above-described function, and is selected according to the purpose. Examples thereof include a known developing machine having a function of attaching a single-component developer or a two-component developer to the electrophotographic photoreceptor 7 using a brush, a roller, or the like. Among the examples, it is preferable to use a developing roller holding developer on a surface thereof.

The developer used for the developing unit 11 may be a single-component developer of toner alone or a two-component developer including toner and a carrier. In addition, the developer may be magnetic or nonmagnetic. Known developers are adopted to these developers.

Cleaning Unit

As the cleaning unit 13, a cleaning blade type unit including a cleaning blade 131 is used.

In addition to the cleaning blade type, a fur brush cleaning type and a development simultaneous cleaning type may be adopted.

Transfer Unit

Examples of the transfer unit 40 include a contact type transfer charging member using a belt, a roller, a film, a rubber blade, or the like and a transfer charging member known as it is such as a scorotron transfer charging member or a corotron transfer charging member using corona discharge.

Intermediate Transfer Member

As the intermediate transfer member 50, a belt-shaped member (intermediate transfer belt) containing polyimide, polyamideimide, polycarbonate, polyarylate, polyester, rubber, or the like to which semiconductivity is imparted is used. In addition, as a form of the intermediate transfer member, a drum-shaped member may be used in addition to the belt shape.

Control Unit

The control unit 62 is configured as a computer that controls the entire image forming apparatus and performs various calculations. Specifically, the control unit 62 includes, for example, a central processing unit (CPU), a read only memory (ROM) storing various programs, a random access memory (RAM) used as a work area when executing the programs, a nonvolatile memory storing various information, and an input/output interface (I/O). The CPU, the ROM, the RAM, the nonvolatile memory, and the I/O are connected to one another via a bus. Each unit of the image forming apparatus 100 such as the electrophotographic photoreceptor 7, the charging unit 8, the exposure unit 9, the developing unit 11, the transfer unit 40, and the cleaning unit 13 is connected to the I/O.

The CPU executes, for example, a program (for example, a control program for an image forming sequence or a recovery sequence) stored in the ROM or the non-volatile memory, and controls an operation of each unit of the image forming apparatus 100. The RAM is used as a work memory. The ROM or the non-volatile memory stores, for example, a program executed by the CPU and data necessary for the CPU processing. The control program or various data may be stored in another storage unit such as a storage unit, or may be acquired from an outside via a communication unit.

Also, various drives may be connected to the control unit 62. Examples of the various drives include a unit that reads data from a computer-readable portable recording medium P such as a flexible disk, magneto-optical disk, CD-ROM, DVD-ROM, or universal serial bus (USB) memory, or writes data on the recording medium P. In a case where various drives are provided, a control program may be recorded on the portable recording medium P, and a corresponding drive reads and executes the program.

For example, when the image forming apparatus 100 is electrically connected to the control unit 62 that controls the operation of each unit and each member in the image forming apparatus 100, and thus, is driven and controlled by the control unit 62, the transport speed of the recording medium is set to be from 50 mm/sec to 200 mm/sec.

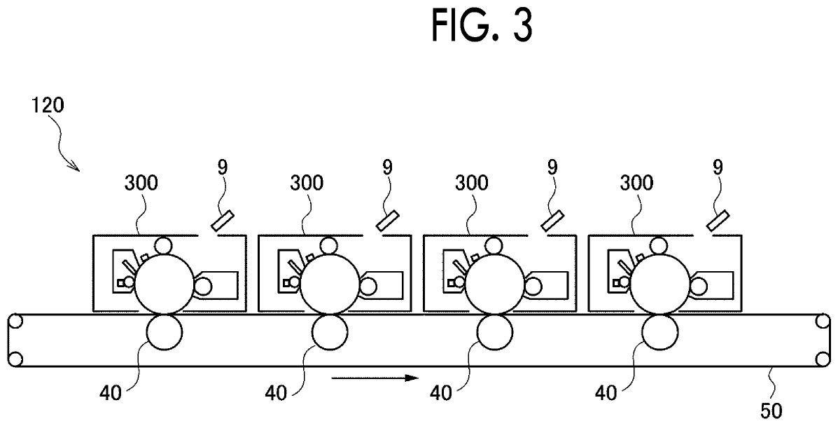

FIG. 3 is a schematic configuration diagram illustrating another example of the image forming apparatus according to the exemplary embodiment.

An image forming apparatus 120 shown in FIG. 3 is a tandem multicolor image forming apparatus on which four process cartridges 300 are mounted. The image forming apparatus 120 has a configuration in which four process cartridges 300 are arranged in parallel on the intermediate transfer member 50 and one electrophotographic photoreceptor is used for each color. The image forming apparatus 120 has the same configuration as that of the image forming apparatus 100 except for the tandem type.

### EXAMPLES

Hereinafter, the present invention will be described with reference to examples, but the present invention is not limited to the following examples. Unless otherwise noted, “part(s)” means “part(s) by weight”.

### Example 1

Preparation of Undercoating Layer

100 parts by weight of zinc oxide as metal oxide particles (volume average particle diameter: 70 nm, manufactured by Tayca Corporation, and BET specific surface area: 15 m²/g) are mixed to 500 parts by weight of methanol with stirring, and 1.25 parts by weight of KBM603 (manufactured by Shin-Etsu Chemical Co., Ltd.) as a silane coupling agent is added thereto and stirred for 2 hours. Thereafter, the methanol is distilled off by distillation under reduced pressure and the resultant is baked at 120° C. for 3 hours to obtain zinc oxide particles surface-treated with a silane coupling agent.

44.6 parts by weight of the zinc oxide particles surface-treated with a silane coupling agent and 0.45 parts by weight of hydroxyanthraquinone “Exemplary Compound (1-1)” as the electron accepting compound, 10.2 parts by weight of blocked isocyanate (SUMIDUR BL 3173, manufactured by Sumitomo Bayer Urethane Co., Ltd.) as the curing agent, 3.5 parts by weight of butyral resin (trade name: ESREX BM-1, manufactured by Sekisui Chemical Co., Ltd.), 0.005 parts by weight of dioctyltin dilaurate as a catalyst, and 41.3 parts by weight of methyl ethyl ketone are mixed, and dispersed for 4.1 hours in a sand mill using glass beads each having a diameter of 1 mm (that is, dispersing time: 4.1 hours) to obtain dispersion. 3.6 Parts by weight of silicone resin particles (TOSPEARL 145, manufactured by Momentive) are added to the obtained dispersion, thereby obtaining an undercoating layer-forming coating liquid. The viscosity of the undercoating layer-forming coating liquid at a coating temperature of 24° C. is 235 mPa·s.

With the undercoating layer-forming coating liquid, a conductive substrate (an aluminum substrate, diameter of 30 mm, length of 365 mm, and wall thickness of 1.0 mm) is coated by a dipping coating method at a coating speed of 220 mm/min, and the resultant is dried and cured at 190° C. for 24 minutes to obtain an undercoating layer having a thickness of 19 μm.

Preparation of Charge Generation Layer

A mixture including 15 parts by weight of hydroxygallium phthalocyanine having diffraction peaks at Bragg angles (2θ±0.2°) of at least 7.3°, 16.0°, 24.9°, and 28.0° in an X-ray diffraction spectrum using a Cu Kα characteristic X-ray as the charge generation substance, 10 parts by weight of vinyl chloride-vinyl acetate copolymer binder resin (VMCH, manufactured by Nippon Unicar Company Limited) as binder resin, and 200 parts by weight of n-butyl acetate is dispersed with stirring for 4 hours with a sand mill using glass beads having a diameter of 1 mmφ. 175 parts by weight of n-butyl acetate and 180 parts by weight of methyl ethyl ketone are added to the obtained dispersion and stirred to obtain a charge generation layer-forming coating liquid. Dipping coating is performed on the undercoating layer with the charge generation layer-forming coating liquid. Thereafter, drying is performed at 140° C. for 10 minutes to form a charge generation layer having a film thickness of 0.2 μm.

Preparation of Charge Transport Layer

40 parts by weight of charge transporting agent (HT-1), 8 parts by weight of charge transporting agent (HT-2), and 52 parts by weight of polycarbonate binder resin (A) (viscosity average molecular weight 50,000) are added to 800 parts by weight of tetrahydrofuran, and dissolved therein. 8 parts by weight of tetrafluoroethylene binder resin (manufactured by Daikin Industries Ltd., LUBRON L5, average particle diameter of 300 nm) is added thereto and dispersed at 5,500 rpm for 2 hours using a homogenizer (ULTRA-TURRAX manufactured by IKA) to obtain a charge transport layer-forming coating liquid. This coating liquid is applied onto the above-described charge generation layer. Thereafter, drying is performed at 140° C. for 40 minutes to form a charge transport layer having a film thickness of 27 μm. Thus, an electrophotographic photoreceptor is obtained.

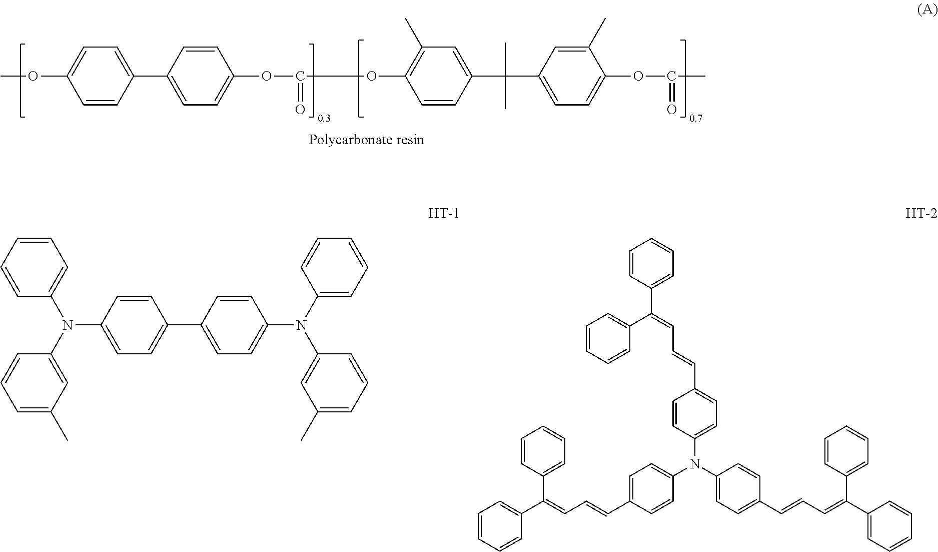

### Examples 2 to 8 and Comparative Example 1

The same operations as those of Example 1 except that, in the preparation of the undercoating layer, dispersing time, kinds and contents of the metal oxide particles, and an abundance ratio of the metallic element are changed according to Table 1 are performed to obtain an electrophotographic photoreceptor of each example. The “Dispersing time” in Table 1 refers to the dispersing time in a preparation step of the undercoating layer.

### Example 9

The same operations as those of Example 1 except that in the preparation of the undercoating layer, a material and the amount of the binder resin are changed to 40 parts by weight of “phenol resin (WR-103, manufactured by DIC Corporation)”, and kinds and the amount of the solvent are changed from 41.3 parts by weight of methyl ethyl ketone to 60 parts by weight of “cyclohexanone (Fujifilm Wako Pure Chemical Industries, Ltd.)” are performed to obtain an electrophotographic photoreceptor of Example 9.

Evaluation of Black Spot

The electrophotographic photoreceptor obtained above is mounted on a modified version of an image forming apparatus (DocuCentre-V C2275, manufactured by Fuji Xerox Co., Ltd.). Then, in the image forming apparatus, the transport speed of the recording medium is set to 125 mm/sec, and the charged potential of the surface of the electrophotographic photoreceptor charged by the charging unit is set to −800 V. Using the image forming apparatus, halftone image having an image density of 30% is output on 5 sheets of A3 size paper in an environment of a temperature of 28° C. and a humidity of 85%. The obtained halftone image is visually observed and a black spot is evaluated in accordance with the following evaluation criteria. Acceptable ranges are A and B.

Evaluation Criteria
A: No black spot
B: Occurrence of 1 to 5 black spots
C: Occurrence of more than 5 black spots

TABLE 1

| | | | | | Abundance | |
|---|---|---|---|---|---|---|
| | Metal oxide particles | | | | ratio of | |
| | | Amount | Binder | Dispersing | metallic | |
| | | (% by | resin | time | element | Evaluation |
| | Kind | weight) | Kind | (hours) | (%) | Black spot |
| Example 1 | Zinc oxide | 70 | Urethane | 4.1 | 3.3 | A |
| | particles | | | | | |
| Example 2 | Zinc oxide | 70 | Urethane | 4.2 | 2.9 | A |
| | particles | | | | | |
| Example 3 | Titanium | 70 | Urethane | 4.1 | 3.3 | A |
| | oxide particles | | | | | |
| Example 4 | Tin oxide | 70 | Urethane | 4.1 | 3.3 | A |
| | particles | | | | | |
| Example 5 | Zinc oxide | 70 | Urethane | 4.0 | 3.9 | B |
| | particles | | | | | |
| Example 6 | Zinc oxide | 70 | Urethane | 150.0 | 0.3 | A |
| | particles | | | | | |
| Example 7 | Zinc oxide | 60 | Urethane | 3.5 | 3.2 | A |
| | particles | | | | | |
| Example 8 | Zinc oxide | 75 | Urethane | 5.0 | 3.3 | A |
| | particles | | | | | |
| Example 9 | Zinc oxide | 70 | Phenol | 4.1 | 3.3 | A |
| | particles | | | | | |
| Comparative | Zinc oxide | 70 | Urethane | 3.9 | 4.0 | C |
| Example 1 | particles | | | | | |

From the above results, it is found that, in the electrophotographic photoreceptors according to the examples, the evaluation of the black spot when forming an image is better, as compared with the electrophotographic photoreceptors according to the comparative example. That is, it may be seen that in the electrophotographic photoreceptors of the examples, a color spot is prevented when forming an image, compared to the electrophotographic photoreceptors of the comparative example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
an undercoating layer which is provided on the conductive substrate and contains a binder resin and metal oxide particles; and
a photosensitive layer provided on the undercoating layer,
wherein, with respect to a surface of the undercoating layer, on which the photosensitive layer is provided, a ratio of an abundance of a metallic element to an abundance of a metallic element and a carbon element, which are detected by X-ray photoelectron spectroscopic analysis, is 3.9% or less.

2. The electrophotographic photoreceptor according to claim 1,
wherein the ratio is less than 3.8%.

3. The electrophotographic photoreceptor according to claim 2,
wherein the ratio is 0.3% or more and less than 3.8%.

4. The electrophotographic photoreceptor according to claim 1,
wherein a content of the metal oxide particles with respect to the binder resin is from 10% by weight to 85% by weight.

5. The electrophotographic photoreceptor according to claim 4,
wherein a content of the metal oxide particles with respect to the binder resin is from 10% by weight to 70% by weight.

6. The electrophotographic photoreceptor according to claim 1,
wherein the binder resin is at least one selected from the group consisting of phenol resin, melamine resin, guanamine resin, and urethane resin.

7. The electrophotographic photoreceptor according to claim 6,
wherein the binder resin is at least one selected from the group consisting of the phenol resin and the urethane resin.

8. The electrophotographic photoreceptor according to claim 1,
wherein the metal oxide particles are at least one selected from the group consisting of zinc oxide particles, titanium oxide particles, and tin oxide particles.

9. The electrophotographic photoreceptor according to claim 8,
wherein the metal oxide particles are zinc oxide particles.

10. A process cartridge that is detachable from an image forming apparatus, the process cartridge comprising:
the electrophotographic photoreceptor according to claim 1.

11. An image forming apparatus comprising:
the electrophotographic photoreceptor according to claim 1;
a charging unit that charges a surface of the electrophotographic photoreceptor;
an electrostatic latent image forming unit that forms an electrostatic latent image on a charged surface of the electrophotographic photoreceptor;
a developing unit that develops the electrostatic latent image formed on the surface of the electrophotographic photoreceptor with a developer including toner to form a toner image; and
a transfer unit that transfers the toner image onto a surface of a recording medium.

12. The image forming apparatus according to claim 11,
wherein a transport speed of the recording medium is from 50 mm/sec to 200 mm/sec.

13. The image forming apparatus according to claim 11,
wherein a charged potential of the surface of the electrophotographic photoreceptor after being charged by the charging unit is from −1,200 V to −600 V.
